(19) United States
(12) Patent Application Publication
(10) Pub. No.: US 2014/0248075 A1
(43) Pub. Date: Sep. 4, 2014

(54) PADDLE SHAFT LENGTH ADJUSTMENT DEVICE

(71) Applicant: Hee Jae Lee, Incheon (KR)

(72) Inventor: Hee Jae Lee, Incheon (KR)

(73) Assignee: WOOSUNG I.B CO., LTD., Incheon (KR)

(21) Appl. No.: 14/351,140

(22) PCT Filed: Feb. 2, 2012
(86) PCT No.: PCT/KR2012/000817

§ 371 Date: Apr. 10, 2014

(30) Foreign Application Priority Data
Oct. 14, 2011 (KR) 10-2011-0105052

(51) Int. Cl. B63H 16/04; F16B 7/10

(52) U.S. Cl. CPC B63H 16/04; F16B 7/10
USPC 403/109.1

(57) ABSTRACT

Disclosed is a paddle shaft length adjustment device in which a connection end portion of a large-diameter first shaft is connected and secured to a connector pipe via simplified insertion to ensure easy assembly between the first shaft and the connector pipe, and a second shaft is secured by reducing the diameter of a contractible pipe portion of the resilient connector pipe, thereby allowing the length adjustment device to be repeatedly used with a paddle shaft formed of a non-elastic material, such as aluminum. The paddle shaft length adjustment device includes snap insertion holes perforated in the front and rear sides of a connection end portion of a tubular first shaft, a second shaft shaped to be inserted into the first shaft, a connector pipe consisting of, on the basis of a boundary wall formed at a middle position of an inner bore thereof, an expandable pipe portion at one side of the boundary, into which the connection end portion of the first shaft is inserted, and a contractible pipe portion at the other side of the boundary, into which the second shaft to be inserted into the first shaft is inserted such that an outer circumferential surface of the second shaft comes into close contact with an inner circumferential surface of the contractible pipe portion, the connector pipe having a longitudinal elongated slot perforated in the top of the contractible pipe portion, front and rear snap type retainers provided at the front and rear sides of the expandable pipe portion and configured to be snap fitted into the snap insertion holes perforated in the front and rear sides of the first shaft, and a clamping member provided at the contractible pipe portion of the connector pipe, the clamping member securing the second shaft to the contractible pipe portion by reducing the width of the elongated slot, and consequently reducing the diameter of the contractible pipe portion.

### TECHNICAL FIELD

The present invention relates to a length adjustment device for a paddle shaft, and more particularly to a paddle shaft length adjustment device, in which a connection end portion of a first shaft having a large diameter is connected and secured to a connector pipe via simplified insertion, and a second shaft is directly secured to a contractible pipe portion of the resilient connector pipe under reduction in the diameter of the contractible pipe portion, whereby the paddle shaft length adjustment device may be repeatedly used with a paddle shaft formed of a non-elastic material, such as aluminum.

### BACKGROUND ART

Generally, boats are small ships having no deck and more particularly are small vessels for transporting people and cargo or small ships for specialized use, such as pleasure and racing. These boats are divided into a short boat shaped to permit propulsion using a paddle shaft by manpower, and a yacht as a sailboat shaped to permit propulsion by wind power.

Paddles for use in the short boat are divided into a paddle having a shaft with blades at both ends, used in a kayak or the like, and a paddle having a shaft with a blade at one end and a handle at the other end, used in a canoe, a small boat for transportation, or the like.

A known conventional paddle is disclosed in Japanese Patent Laid Open Publication No. 1999-49094.

The disclosed conventional paddle includes a single shaft, a blade provided at one end of the shaft, and a handle provided at the other end of the shaft.

The conventional paddle having the above described configuration, however, has a problem in that the single shaft is beyond length adjustment, and therefore the length of the shaft cannot be adjusted to conform to the body size of a user.

To solve the above described problem, conventionally, a length adjustment device for use with two half shafts, which is adapted to interconnect the two half shafts to each other in a length adjustable manner, has been known.

FIG. 7 shows a conventional length adjustment device for a paddle shaft. The conventional paddle shaft length adjustment device is adapted to interconnect a first shaft 100, having a large diameter, and a second shaft 200, sized to be inserted into the first shaft 100, to each other, so as to adjust the total length of a paddle shaft.

In addition, the conventional paddle shaft length adjustment device includes an elongated slot 101 longitudinally perforated in a connection end portion of the large diameter first shaft 100, a connector pipe 300, an inner circumferential surface of which is wholly adhesively bonded to an outer circumferential surface of the connection end portion using an adhesive 301, and a clamping member 400 coupled to the connector pipe 300 at a position near one end of the connector pipe, the clamping member 400 serving to reduce the diameter of the connection end portion of the first shaft 100 to allow the second shaft 200, inserted into the connection end portion of the first shaft 100, to be press-fitted.

Accordingly, when attempting to interconnect the first and second shafts 100 and 200 to each other via the conventional paddle shaft securing mechanism having the above described configuration, in a state in which the second shaft 200 is inserted into the first shaft 100, the clamping member 400 is manually operated to reduce the diameter of the connection end portion of the first shaft 100, thereby enabling press-fit securing of the second shaft 200.

However, in a case in which the first and second shafts are fabricated using a non-elastic material, such as, for example, aluminum, after interconnection of the first and second shafts, the first shaft continuously remains at the reduced diameter because it has no resilience.

Consequently, in the case of the first shaft fabricated using a material having no resilience, the connection end portion of the first shaft continuously remains at the reduced inner diameter, which makes it impossible to repeatedly adjust the length or angle of the first and second shafts.

In addition, due to the fact that the connector pipe provided with the clamping member is adhesively bonded to the connection end portion of the first shaft using the adhesive, coupling between the connector pipe and the first shaft is troublesome and time consuming.

### DISCLOSURE

### Technical Problem

Therefore, the present invention has been made to solve the above described problems.

It is an object of the present invention to provide a paddle shaft length adjustment device, in which a connection end portion of a first shaft having a large diameter is connected and secured to a connector pipe via simplified insertion, and a second shaft is directly secured to a contractible pipe portion of the resilient connector pipe under reduction in the diameter of the contractible pipe portion such that an insertion length of the second shaft into the first shaft or an angle of the second shaft relative to the first shaft is adjustable, whereby the paddle shaft length adjustment device may be repeatedly used with a paddle shaft formed of a non-elastic material.

Also, it is another object of the present invention to provide a paddle shaft length adjustment device, in which a first shaft is secured to a connector pipe such that an end of a connection end portion of the first shaft comes into close contact with a boundary wall formed at a middle position of an inner circumferential surface of the connector pipe, which may prevent the first shaft from being finely moved in a longitudinal direction thereof.

Also, it is another object of the present invention to provide a paddle shaft length adjustment device, in which, in a state in which a connection end portion of a first shaft is inserted into and secured to a connector pipe, upper and lower ends of elastic snap plates protruding inward from the front and rear sides of an expandable pipe portion of the connector pipe come into close contact with upper and lower ends of snap insertion holes perforated in the front and rear sides of the connection end portion of the first shaft, which may prevent the first shaft from being finely rotated and moved inside the connector pipe.

Also, it is another object of the present invention to provide a paddle shaft length adjustment device, in which, in a process of inserting and securing a connection end portion of a first shaft into an expandable pipe portion of a connector pipe, more rapid and easier position coincidence between snap insertion holes perforated in the front and rear sides of the connection end portion of the first shaft and snap type retainers formed at the front and rear sides of the connector pipe may be accomplished.

Also, it is another object of the present invention to provide a paddle shaft length adjustment device, in which a circumferential elongated slot is formed at one side of a longitudinal elongated slot formed in the top of a contractible pipe portion of a connector pipe, which enables increase or reduction in the diameter of the contractible pipe portion by less force.

Also, it is a further object of the present invention to provide a paddle shaft length adjustment device, in which a clamping member is provided at the exterior of a contractible pipe portion of a connector pipe to directly secure the second shaft to the connector pipe, which may further enhance the connection strength of the first and second shafts.

### Technical Solution

In accordance with an aspect of the present invention, the above and other objects can be accomplished by the provision of a paddle shaft length adjustment device including snap insertion holes perforated in the front and rear sides of a connection end portion of a first shaft having a tubular shape; a second shaft shaped to be inserted into the first shaft; a connector pipe consisting of, on the basis of a boundary wall formed at a middle position of an inner bore thereof, an expandable pipe portion at one side of the boundary, into which the connection end portion of the first shaft is inserted, and a contractible pipe portion at the other side of the boundary, into which the second shaft to be inserted into the first shaft is inserted such that an outer circumferential surface of the second shaft comes into close contact with an inner circumferential surface of the contractible pipe portion, the connector pipe having a longitudinal elongated slot perforated in the top of the contractible pipe portion; front and rear snap type retainers provided at the front and rear sides of the expandable pipe portion, the front and rear snap type retainers being configured to be snap fitted into the snap insertion holes perforated in the front and rear sides of the first shaft; and a clamping member provided at the contractible pipe portion of the connector pipe, the clamping member securing the second shaft to the contractible pipe portion by reducing the width of the elongated slot, and consequently reducing the diameter of the contractible pipe portion.

Also, the snap insertion holes may have a rectangular shape; and each of the snap type retainers may include a rectangular hole perforated in the expandable pipe portion and an elastic snap plate obliquely protruding from one end of the rectangular hole so as to be snap fitted at one end thereof into a corresponding one of the snap insertion holes.

Also, a length from an end of the connection end portion of the first shaft to the snap insertion holes may be equal to a length from the boundary wall to the elastic snap plates.

Also, in a state in which the elastic snap plates are snap fitted into the respective snap insertion holes, upper and lower ends of the elastic snap plates may come into close contact with upper and lower ends of the snap insertion holes.

Also, the paddle shaft length adjustment device may further include a projection protruding from the bottom center of the boundary wall to the expandable pipe portion, and an insertion recess indented in the bottom of the connection end portion of the first shaft for insertion of the projection.

Also, a circumferential elongated hole may further be formed in the top center of the connector pipe.

Also, an inner diameter of the expandable pipe portion may be greater than an inner diameter of the contractible pipe portion.

Also, the clamping member may include domed reinforcement portions raised upward from the front and rear sides of the elongated slot, front and rear through-holes perforated transversely to the longitudinal direction of the front and rear domed reinforcement portions respectively, a push face formed in a front face of the front domed reinforcement portion, an operating shaft inserted into the front and rear through-holes, the operating shaft consisting of a separation preventing head formed at a rear end thereof and a front shaft body protruding from the separation preventing head, and a securing lever, an upper end of which is connected to a front end of the operating shaft via a hinge shaft, the hinge shaft extending transversely to a longitudinal direction of the lever, the securing lever having a cam face provided around the hinge shaft and adapted to come into close contact with the push face to allow the securing lever to move the operating shaft forward or rearward as the securing lever is rotated about the hinge shaft, thereby reducing or increasing the width of the elongated slot.

### Advantageous Effects

As is apparent from the above description, a connection end portion of a first shaft having a large diameter is connected and secured to a connector pipe via simplified insertion, which may ensure easy assembly between the first shaft and the connector pipe, thereby providing use and manufacturing convenience. Moreover, as a result of securing a second shaft by reducing the diameter of a contractible pipe portion of the resilient connector pipe, a paddle shaft length adjustment device of the present invention may be repeatedly used with a paddle shaft formed of a non-elastic material. Consequently, the paddle shaft length adjustment device is advantageously compatible with a paddle shaft formed of a non-elastic material, such as, for example, aluminum, as well as a paddle shaft formed of an elastic material, such as, for example, carbon and synthetic resin.

Also, the first shaft is secured to the connector pipe such that an end of the connection end portion of the first shaft comes into close contact with a boundary wall formed at a middle position of an inner circumferential surface of the connector pipe. With this configuration, it is possible to prevent the first shaft from being finely moved in a longitudinal direction thereof, which may provide convenience and stability during rowing.

Also, it is possible to prevent the first shaft from being finely rotated and moved inside the connector pipe, which may provide convenience and stability during rowing.

Also, convenience and stability during rowing may be accomplished by preventing the first shaft from being rotated and moved inside the connector pipe. In addition, in a process of inserting and securing the connection end portion of the first shaft into the expandable pipe portion of the connector pipe, more rapid and easier position coincidence between the snap insertion holes perforated in the front and rear sides of the connection end portion of the first shaft and snap type retainers formed at the front and rear sides of the connector pipe may be accomplished, which may enhance use convenience and productivity of a paddle.

Also, through provision of a circumferential elongated slot at one side of a longitudinal elongated slot formed in the top of the contractible pipe portion of the connector pipe, the diameter of the contractible pipe portion may be increased or reduced by less force.

Also, as a result of providing a clamping member at the exterior of the contractible pipe portion of the connector pipe to directly secure the second shaft to the connector pipe, it is possible to further enhance the connection strength of the first and second shafts, which may prevent an accident caused by unintentional separation of the first and second shafts during rowing.

### DESCRIPTION OF DRAWINGS

FIG. 1 is a perspective view showing a state in which a paddle shaft length adjustment device of the present invention is mounted to a paddle with blades at both ends thereof.

FIG. 2 is a perspective view showing a state in which the paddle shaft length adjustment device of the present invention is mounted to a paddle with a single blade.

FIG. 3 shows the paddle shaft length adjustment device of the present invention, wherein FIG. 3A is a perspective view, FIG. 3B is an exploded perspective view of first and second shafts, FIG. 3C is a partially cut-away perspective view, FIG. 3D is a half cut-away perspective view, and FIG. 3E is an exploded perspective view of a clamping member.

FIG. 4 is a sectional view taken along line A-A of FIG. 3A.

FIG. 5 is a sectional view taken along line B-B of FIG. 4.

FIG. 6 is a sectional view taken along line C-C of FIG. 5, wherein FIG. 6A shows a secured state of the second shaft, and FIG. 6B shows a released state of the second shaft.

FIG. 7 is a partial exploded perspective view showing a conventional paddle shaft length adjustment device.

### BEST MODE

Hereinafter, the present invention will be described in more detail with reference to the accompanying drawings. It will be appreciated that the accompanying drawings are intended to provide more detailed description of the technical sprit of the present invention, and the technical sprit of the present invention should not be limited thereto.

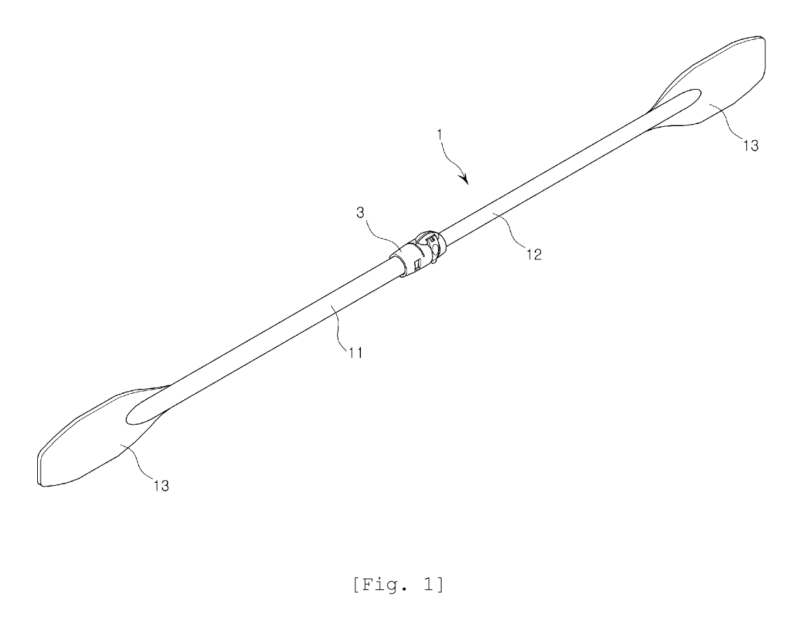

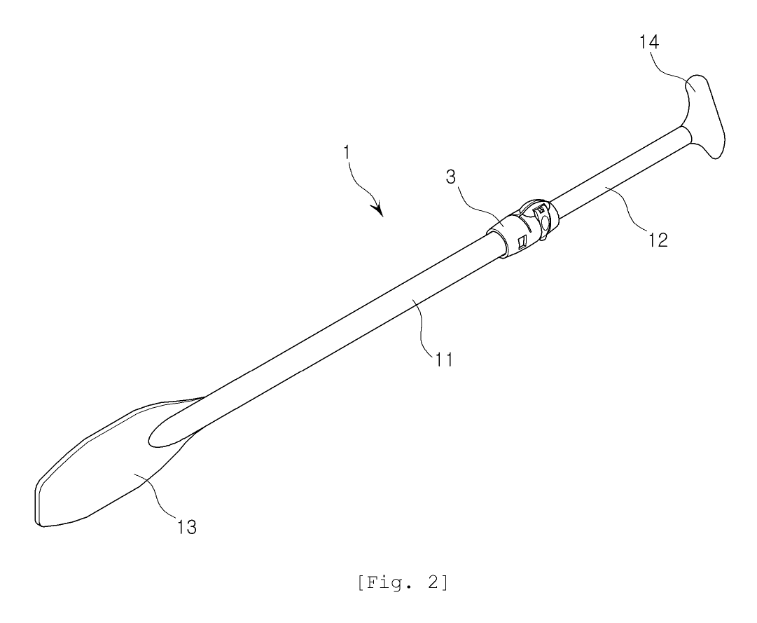

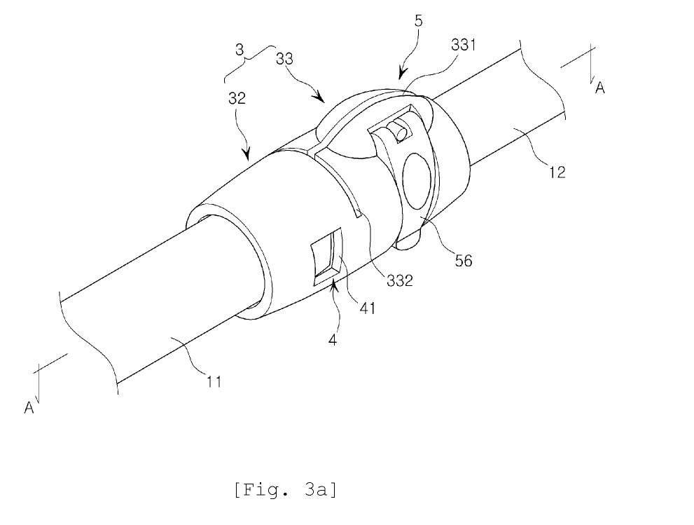

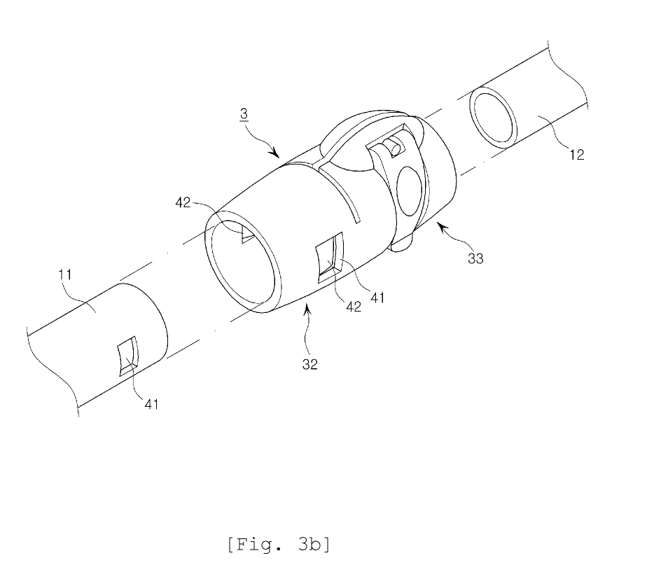

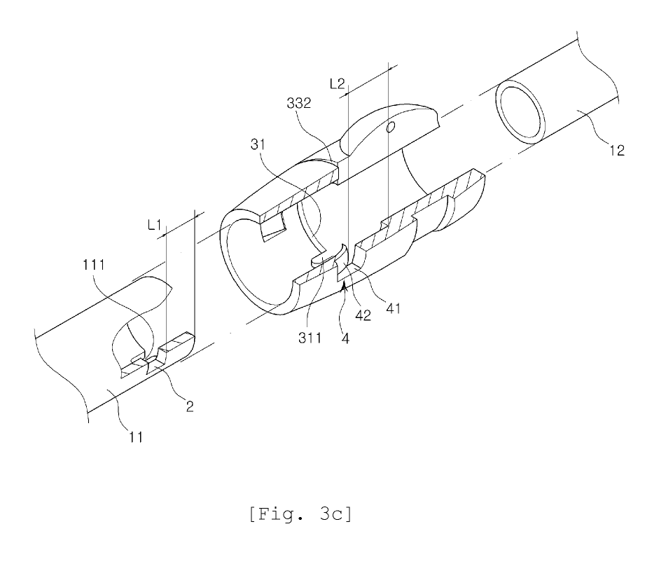

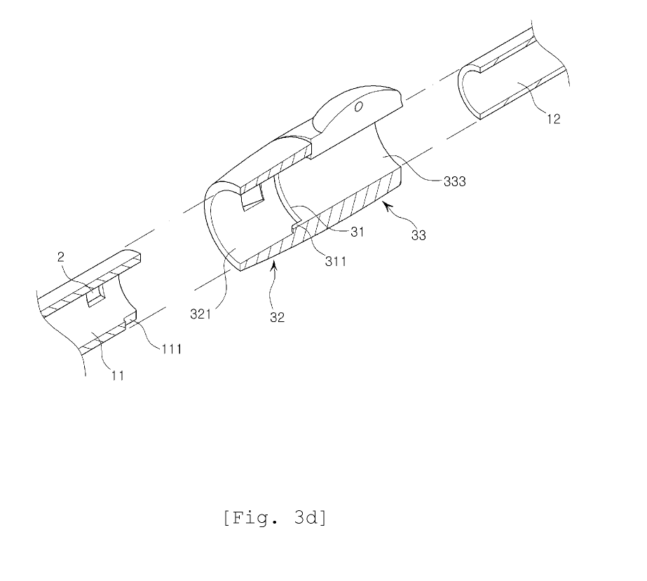

FIG. 1 is a perspective view showing a state in which a paddle shaft length adjustment device of the present invention is mounted to a paddle with blades at both ends thereof, and FIG. 2 is a perspective view showing a state in which the paddle shaft length adjustment device of the present invention is mounted to a paddle with a single blade. In addition, FIG. 3 shows the paddle shaft length adjustment device of the present invention, FIG. 3A is a perspective view, FIG. 3B is an exploded perspective view of first and second shafts, FIG. 3C is a partially cut-away perspective view, FIG. 3D is a half cut-away perspective view, and FIG. 3E is an exploded perspective view of a clamping member.

As exemplarily shown in the drawings, the paddle shaft length adjustment device of the present invention is usable with a paddle having a paddle shaft 1 with blades 13 at both ends, used in a kayak or the like, and a paddle having a shaft with a blade 13 at one end and a handle 14 at the other end, used in a canoe, a small boat for transportation, or the like. More specifically, the paddle shaft length adjustment device of the present invention serves to adjust the length or angle of the paddle shaft 1 of a paddle, provided at both ends thereof with the blades 13, or the paddle shaft 1 of a paddle provided at one end thereof with the blade 13.

The paddle shaft length adjustment device of the present invention includes snap insertion holes 2 perforated in the circumference of a connection end portion of a first shaft 11 having a tubular shape; a second shaft 12 shaped to be inserted into the first shaft 11; a connector pipe 3 consisting of an expandable pipe portion 32 and a contractible pipe portion 33 at both sides of an inner bore, into which the first and second shafts 11 and 12 being inserted respectively, the connector pipe 3 having a longitudinal elongated slot 331 perforated in the top of the contractible pipe portion 33; front and rear snap type retainers 4 provided at the front and rear sides of the expandable pipe portion 32, the front and rear snap type retainers being configured to be snap fitted into the snap insertion holes 2 perforated in the front and rear sides of the circumference of the first shaft 11; and a clamping member provided at the contractible pipe portion 33 of the connector pipe 3.

The paddle shaft according to the present invention, as exemplarily shown in FIGS. 1 to 3, consists of the tubular first shaft 11 provided at one end thereof with the blade 13, and the second shaft 12, one end of which is inserted into the connection end portion of the first shaft 11 and the other end of which is provided with the blade 13 or the handle 14.

The first and second shafts 11 and 12 have a tubular shape. Representative widely used constituent materials of the paddle shaft include aluminum or carbon. Aluminum is advantageously low cost, but is inelastic, whereas carbon is disadvantageously high cost, but is light and elastic.

The snap insertion holes 2 according to the present invention, as exemplarily shown in FIGS. 1 to 3, serve to permit the snap type retainers 4 provided at the front and rear sides of the expandable pipe portion 32 to be snap fitted thereinto, and have a rectangular shape. More specifically, as the snap type retainers 4 protruding inward from the expandable pipe portion 32 are snap fitted into the rectangular snap insertion holes 2, the first shaft 11 is secured to the expandable pipe portion 32 of the connector pipe 3.

The connector pipe 3 according to the present invention, as exemplarily shown in FIGS. 2 and 3, is configured such that the first shaft 11 is inserted into the expandable pipe portion 32 and the second shaft 12, which will be inserted into the shaft 11, is inserted into the contractible pipe portion 33, thereby serving to secure the second shaft 12 under the assistance of the clamping member 5.

The connector pipe 3 consists of, on the basis of a boundary wall 31 formed at a middle position of the inner bore thereof, the expandable pipe portion 32 at one side of the boundary, into which the connection end portion of the first shaft is inserted, and the contractible pipe portion 33 at the other side of the boundary, into which the second shaft 12, which will be inserted into the first shaft 11, is inserted such that an outer circumferential surface of the second shaft comes into close contact with an inner circumferential surface of the contractible pipe portion. The connector pipe 3 is preferably formed of a synthetic resin that is not easily broken and has some elasticity.

On the basis of the boundary wall 31, the inner diameter of the expandable pipe portion 32 is greater than the inner diameter of the contractible pipe portion 33. As such, an outer circumferential surface of the first shaft 11 comes into close contact with an inner circumferential surface 321 of the expandable pipe portion 32, and the outer circumferential surface of the second shaft 12 comes into close contact with the inner circumferential surface 333 of the contractible pipe portion 33.

The longitudinal elongated slot 331 is perforated in the contractible pipe portion 33. In addition, a circumferential elongated slot 332 is perforated in the top center of the connector pipe 3 at one side of the longitudinal elongated slot 331, which assists the contractible pipe portion 33 to be increased or reduced in diameter by less force.

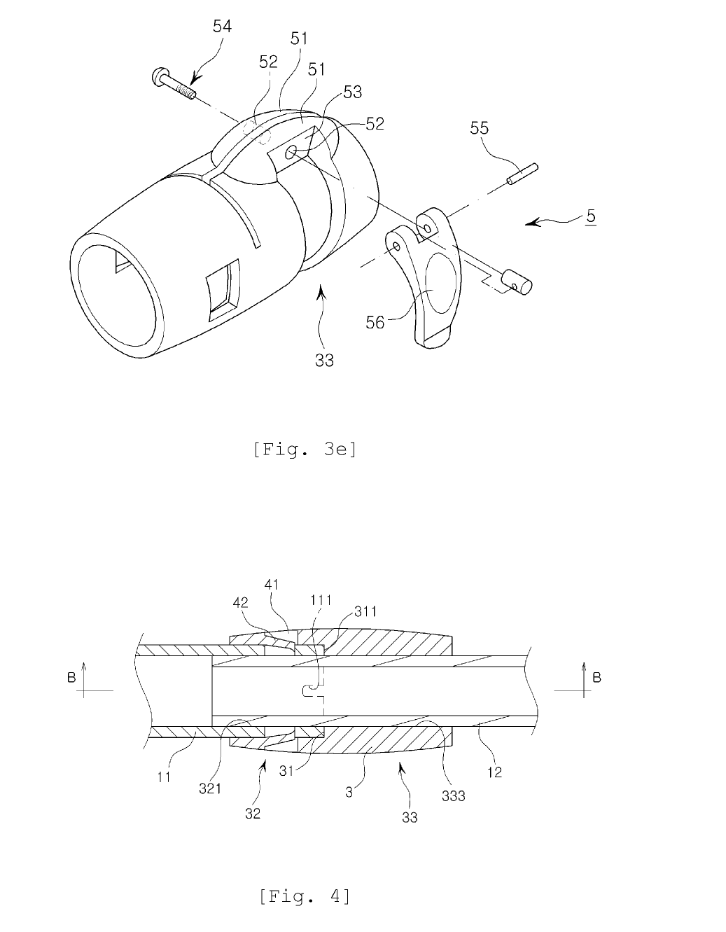

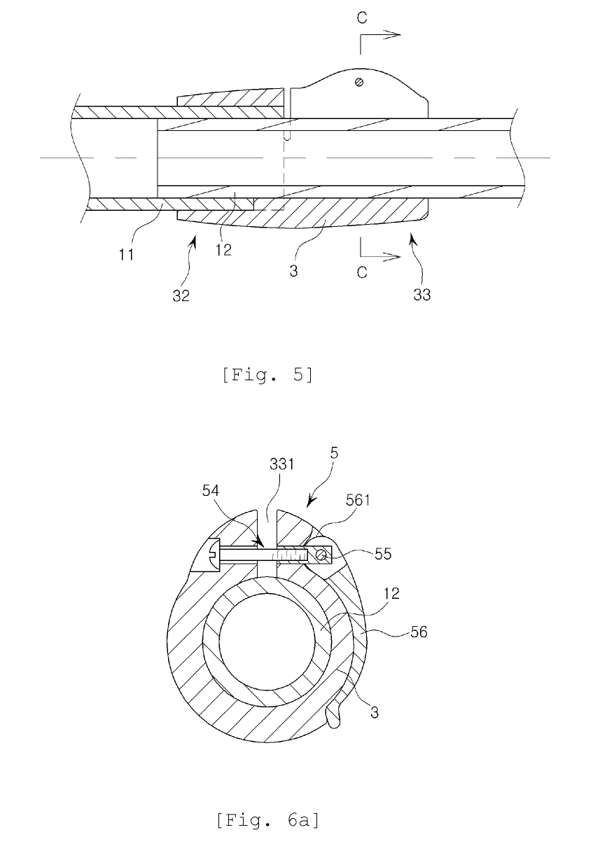

FIG. 4 is a sectional view taken along line A-A of FIG. 3A, and FIG. 5 is a sectional view taken along line B-B of FIG. 4.

The snap type retainers 4 according to the present invention, as exemplarily shown in FIGS. 2 to 4, are arranged at the front and rear sides of the circumference of the expandable pipe portion 32 and configured to be snap fitted into the respective snap insertion holes 2 perforated in the front and rear sides of the connection end portion of the first shaft 11, thereby serving to secure the first shaft to the expandable pipe portion 32. Each of the snap type retainers 4 is comprised of a rectangular hole 41 perforated in the expandable pipe portion 32 and an elastic snap plate 42 obliquely protruding from one end of the rectangular hole 41 so as to be snap fitted at one end thereof into a corresponding one of the snap insertion holes 2.

The elastic snap plate 42 is integrally connected at the other end thereof to an inner edge of the rectangular hole 41. The elastic snap plate has a rectangular shape. As such, the end of the elastic snap plate 42 comes into close contact with a corresponding end of the snap insertion hole to thereby be snap fitted into the snap insertion hole. That is, the elastic snap plate 42 obliquely protrudes inward of the expandable pipe portion 32, which may prevent the elastic snap plate 42 snap fitted into the snap insertion hole 2 from being unintentionally separated from the snap insertion hole.

In a state in which the elastic snap plate 42 is snap fitted into the snap insertion hole 2, upper and lower ends of the elastic snap plate 42 come into close contact with upper and lower ends of the snap insertion hole 2. This may prevent the first shaft 11 from being slightly rotated and moved inside the connector pipe 3, thereby advantageously providing ease and stability during rowing.

The paddle shaft length adjustment device of the present invention, as exemplarily shown in FIGS. 3C and 3D, further includes a projection 311 protruding from the bottom center of the vertical boundary 31 to the expandable pipe portion 32 of the connector pipe 3, and an insertion recess 111 indented in the bottom of the connection end portion of the first shaft 11 for insertion of the projection 311.

A distal end of the projection 311 and an open end of the recess 111 are rounded to allow the projection 311 to be easily inserted into the insertion recess 111.

Accordingly, as the projection 311 formed at the bottom center of the boundary wall 31 is inserted into the insertion recess 111 indented in the bottom of the connection end portion of the first shaft 11, unintentional rotation and movement of the first shaft 11 relative to the connector pipe 3 may be advantageously prevented.

In addition, in the process of inserting the connection end portion of the first shaft 11 into the expandable pipe portion 32 of the connector pipe 3 to secure the first shaft to the connector pipe, more rapid and easier position coincidence between the snap type retainers 4 formed at the front and rear sides of the connector pipe 3 and the snap insertion holes 2 perforated in the front and lower sides of the connection end portion of the first shaft 11 is possible. As such, more rapid installation of the length adjustment device is possible, which may enhance use convenience and productivity of a paddle.

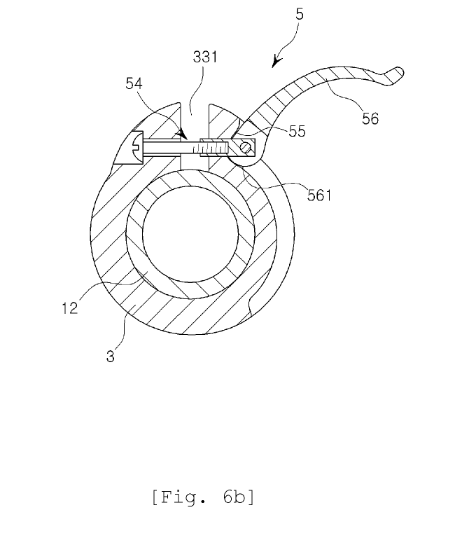

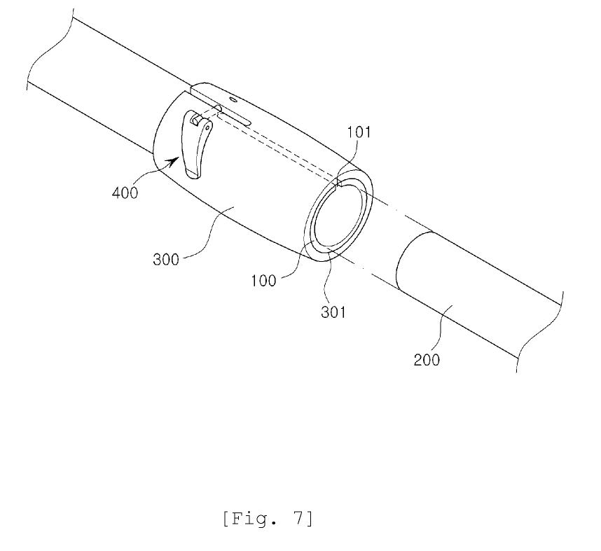

FIG. 6 is a sectional view taken along line C-C of FIG. 5. More specifically, FIG. 6A shows a secured state of the second shaft, and FIG. 6B shows a released state of the second shaft 12.

The clamping member 5 according to the present invention, as exemplarily shown in FIGS. 2 to 6, is located at the contractible pipe portion 33 of the connector pipe 3, and serves to secure the second shaft 12 to the contractible pipe portion 33 by reducing the width of the elongated slot 331, and consequently reducing the diameter of the contractible pipe portion 33.

The clamping member 5 includes domed reinforcement portions 51 raised upward from the front and rear sides of the elongated slot 331; front and rear through-holes 52 perforated transversely to the longitudinal direction of the front and rear domed reinforcement portions 51 respectively; a push face 53 formed in a front face of the front domed reinforcement portion 51; an operating shaft 54 inserted into the front and rear through-holes 52, the operating shaft 54 consisting of a separation preventing head formed at a rear end thereof and a front shaft body protruding from the separation preventing head; and a securing lever 56, an upper end of which is connected to a front end of the operating shaft 54 via a hinge shaft 55, the hinge shaft extending transversely to a longitudinal direction of the lever, the securing lever having a cam face 561 provided around the hinge shaft 55 and adapted to come into close contact with the push face 53 to allow the securing lever to move the operating shaft 54 forward or rearward as the securing lever is rotated about the hinge shaft 55, thereby reducing or increasing the width of the elongated slot 331.

With this configuration, the clamping member 5 is coupled to the exterior of the contractible pipe portion 33 of the connector pipe 3 to directly secure the second shaft 12 to the connector pipe 3, which may further enhance the connection strength of the first and second shafts 11 and 12.

Meanwhile, the paddle shaft length adjustment device of the present invention, as exemplarily shown in FIG. 3C, has a feature in that a length L1 from an end of the connection end portion of the first shaft 11 to the snap insertion hole 2 is equal to a length L2 from the boundary wall 31 to the elastic snap plate 42.

With this configuration, as the first shaft 11 is secured to the connector pipe 3 such that the end of the connection end portion of the first shaft 11 comes into close contact with the boundary wall 31 formed at the middle of the inner surface of the connector pipe 3, it is possible to prevent the first shaft 11 from being finely moved in a longitudinal direction thereof. This may advantageously provide ease and stability during rowing.

Hereinafter, operational relationships between the above described constituent elements of the paddle shaft length adjustment device of the present invention will be described.

As exemplarily shown in FIGS. 1 to 6, in the paddle shaft length adjustment device of the present invention, to assemble the first and second shafts 11 and 12 with each other in a length or angle adjustable manner, first, the connection end portion of the first shaft 11 is inserted into the expandable pipe portion 32 of the connector pipe 3 until the elastic snap plates 42 of the snap type retainers 4 formed at the front and rear sides of the expandable pipe portion 32 are snap fitted into the snap insertion holes 2 formed in the front and rear sides of the connection end portion. In this way, the first shaft 11 is secured to the connector pipe 3.

Once the first shaft 11 has been connected to the connector pipe 3, subsequently, the securing lever 56 of the clamping member 5 is lifted upward to keep the contractible pipe portion 33 at an increased diameter. Then, an insertion length of the second shaft 12 or an angle of the second shaft 12 is adjusted while a connection end portion of the second shaft 12 is inserted into the contractible pipe portion 33 of the connector pipe 3 and then into the connection end portion of the first shaft 11.

Next, as the securing lever 56 of the clamping member 5 is pivotally rotated downward about the hinge shaft 55 to a locking position thereof, the operating shaft 54 is moved forward, causing reduction in the diameter of the contractible pipe portion 33. Thereby, the second shaft 12 is secured to the contractible pipe portion 33 of the connector pipe 3.

In this way, the connection end portion of the first shaft 11 may be connected and secured to the connector pipe 3 via the above described simplified insertion, which may ensure easy assembly between the connector pipe 3 and the first shaft 11, and consequently result in use and manufacturing convenience.

In addition, as a result of securing the second shaft 12 by reducing the diameter of the contractible pipe portion 33 of the connector pipe 3 that is formed of a synthetic resin and thus has resilience, the connector pipe may be repeatedly used with the paddle shaft 1 that is formed of a non-elastic material, such as, for example, aluminum.

Consequently, the paddle shaft length adjustment device of the present invention is advantageously compatible with the paddle shaft 1 formed of a non-elastic material, such as, for example, aluminum, as well as the paddle shaft 1 formed of an elastic material, such as, for example, carbon and synthetic resin.

Although the paddle shaft length adjustment device of the present invention has been described in detail, this is merely the most preferred embodiment of the present invention and the present invention should not be limited thereto, but determined and defined by the accompanying claims. In addition, those skilled in the art will appreciate that various modifications, additions and substitutions are possible, without departing from the scope and spirit of the invention as disclosed in the specification.

[Mode for Invention]

| | |
|---|---|
| 1: paddle shaft | 11: first shaft |
| 111: insertion recess | 12: second shaft |
| 13: blade | 14: handle |
| 2: snap insertion hole | 3: connector pipe |
| 31: boundary wall | 311: projection |
| 32: expandable pipe portion | 321: inner circumferential surface |
| 33: contractible pipe portion | |
| 331: longitudinal elongated slot, | 332: circumferential elongated slot, |
| 333: inner circumferential surface | |
| 4: snap type retainer | 41: rectangular hole |
| 42: elastic snap plate | 5: clamping member |
| 51: domed reinforcement portion | 52: through-hole |
| 53: push face | 54: operating shaft |
| 55: hinge shaft | 56: securing lever |
| 561: cam face | |

1. A paddle shaft length adjustment device comprising:
snap insertion holes (2) perforated in the front and rear sides of a connection end portion of a first shaft (11) having a tubular shape;
a second shaft (12) shaped to be inserted into the first shaft (11);
a connector pipe (3) consisting of, on the basis of a boundary wall (31) formed at a middle position of an inner bore thereof, an expandable pipe portion (32) at one side of the boundary, into which the connection end portion of the first shaft is inserted, and a contractible pipe portion (33) at the other side of the boundary, into which the second shaft (12) to be inserted into the first shaft (11) is inserted such that an outer circumferential surface of the second shaft comes into close contact with an inner circumferential surface of the contractible pipe portion, the connector pipe having a longitudinal elongated slot (331) perforated in the top of the contractible pipe portion (33);
front and rear snap type retainers (4) provided at the front and rear sides of the expandable pipe portion (32), the front and rear snap type retainers being configured to be snap fitted into the snap insertion holes (2) perforated in the front and rear sides of the first shaft (11); and
a clamping member (5) provided at the contractible pipe portion (33) of the connector pipe (3), the clamping member securing the second shaft (12) to the contractible pipe portion (33) by reducing the width of the elongated slot (331), and consequently reducing the diameter of the contractible pipe portion (33).

2. The paddle shaft length adjustment device according to claim 1, wherein the snap insertion holes (2) have a rectangular shape; and each of the snap type retainers (4) includes a rectangular hole (41) perforated in the expandable pipe portion (32) and an elastic snap plate (42) obliquely protruding from one end of the rectangular hole (41) so as to be snap fitted at one end thereof into a corresponding one of the snap insertion holes (2).

3. The paddle shaft length adjustment device according to claim 2, wherein a length (L1) from an end of the connection end portion of the first shaft (11) to the snap insertion holes (2) is equal to a length (L2) from the boundary wall (31) to the elastic snap plates (42).

4. The paddle shaft length adjustment device according to claim 2, wherein, in a state in which the elastic snap plates (42) are snap fitted into the respective snap insertion holes (2), upper and lower ends of the elastic snap plates (42) come into close contact with upper and lower ends of the snap insertion holes (2).

5. The paddle shaft length adjustment device according to claim 1, further comprising:
a projection (311) protruding from the bottom center of the boundary wall (31) to the expandable pipe portion (32); and
an insertion recess (111) indented in the bottom of the connection end portion of the first shaft (11) for insertion of the projection (311).

6. The paddle shaft length adjustment device according to claim 1, wherein a circumferential elongated hole (332) is further formed in the top center of the connector pipe (3).

7. The paddle shaft length adjustment device according to claim 1, wherein an inner diameter of the expandable pipe portion (32) is greater than an inner diameter of the contractible pipe portion (33).

8. The paddle shaft length adjustment device according to claim 1, wherein the clamping member (5) includes domed reinforcement portions (51) raised upward from the front and rear sides of the elongated slot (331), front and rear through-holes (52) perforated transversely to the longitudinal direction of the front and rear domed reinforcement portions (51) respectively, a push face (53) formed in a front face of the front domed reinforcement portion (51), an operating shaft (54) inserted into the front and rear through-holes (52), the operating shaft consisting of a separation preventing head formed at a rear end thereof and a front shaft body protruding from the separation preventing head, and a securing lever (56), an upper end of which is connected to a front end of the operating shaft (54) via a hinge shaft (55), the hinge shaft extending transversely to a longitudinal direction of the lever, the securing lever having a cam face (561) provided around the hinge shaft (55) and adapted to come into close contact with the push face (53) to allow the securing lever to move the operating shaft (54) forward or rearward as the securing lever is rotated about the hinge shaft (55), thereby reducing or increasing the width of the elongated slot (331).
